(19) United States
(12) Patent Application Publication
(10) Pub. No.: US 2013/0231103 A1
(43) Pub. Date: Sep. 5, 2013

(54) CORE NETWORK AND COMMUNICATION SYSTEM

(71) Applicants: Itsuma Tanaka, Yokohama-shi (JP); Kazuhito Tokunaga, Atsugi-shi (JP)

(72) Inventors: Itsuma Tanaka, Yokohama-shi (JP); Kazuhito Tokunaga, Atsugi-shi (JP)

(73) Assignee: NTT DOCOMO, INC., Tokyo (JP)

(21) Appl. No.: 13/884,760

(22) PCT Filed: Nov. 10, 2011
(86) PCT No.: PCT/JP2011/075898

§ 371 Date: May 10, 2013

(30) Foreign Application Priority Data
Nov. 12, 2010 (JP) 2010-254073

(51) Int. Cl. H04W 8/22

(52) U.S. Cl. CPC H04W 8/22
USPC 455/418

(57) ABSTRACT

A core network connected to a mobile communication network and a network and establishing voice communication between communication apparatuses receives a termination notification response indicating at least one codec that can be used by a terminating mobile communication apparatus from the mobile communication apparatus. The core network specifies either a common codec that belongs to the intersection of the at least one codec that can be used by the terminating mobile communication apparatus, indicated in the termination notification response, and an originating codec, or a codec that can be used by the terminating mobile communication apparatus and the core network and that has a transmission rate closest to the transmission rate of the originating codec, as a codec that should be used by the terminating mobile communication apparatus.

### TECHNICAL FIELD

The present invention relates to core networks and communication systems for establishing voice communication between communication apparatuses.

### BACKGROUND ART

In voice communication services using telephones, various codecs have been used. For example, the adaptive multi-rate wideband (AMR-WB) codec has been proposed as a codec for high-quality voice communication services. The AMR-WB, which is an improved version of the AMR codec currently used for telephones around the world, were standardized in 3GPP and are known as G.722.2 in ITU-T (see Non-Patent Documents 1 to 4). In the following description, the conventional AMR codec is called the adaptive multi-rate narrowband (AMR-NB) codec in order to differentiate it from the AMR-WB.

The transmission rate is 4.75 to 12.2 kbits/s in the AMR-NB, whereas the transmission rate in the AMR-WB is one of 12.65, 14.25, 15.85, 18.25, 19.85, 23.05, 23.85 kbits/s etc. The AMR-WB consumes a wider bandwidth than the AMR-NB.

Currently, the AMR-WB has been becoming dominant, but the codecs that can be used in networks depend on networks. For example, a network might use the AMR-WB and the AMR-NB, whereas another network might use only the AMR-NB.

When a mobile communication apparatus, such as a cell phone, performs voice communication with a communication apparatus (such as a fixed-line phone or a cell phone) connected to a communication network other than the mobile communication network to which the mobile communication apparatus subscribes, a core network that connects the mobile communication network to the communication network establishes voice communication between the communication apparatuses. As such a core network, the IP multimedia subsystem (IMS) for establishing voice over Internet protocol (VoIP) communication between communication apparatuses has been proposed (see Non-Patent Document 5). The IMS is also known as a multimedia domain (MMD).

### PRIOR ART DOCUMENTS

### Non-Patent Documents

Non-Patent Document 1: ITU-T Recommendation G.722.2; “Wideband coding of speech at around 16 kbits/s using Adaptive Multi-Rate Wideband (AMR-WB)”, International Telecommunication Union, July 2003
Non-Patent Document 2: 3GPP TS 26.190 V5.1.0 (2001-12), 3rd

Generation Partnership Project; Technical Specification Group Services and System Aspects; Speech Codec speech processing functions; “AMR Wideband speech codec; Transcoding functions”, December 2001
Non-Patent Document 3: 3GPP TS 26.194 V5.0.0 (2001-03), 3rd Generation Partnership Project; Technical Specification Group Services and System Aspects; Speech Codec speech processing functions; “AMR Wideband speech codec; Voice Activity Detector (VAD)”, March 2001
Non-Patent Document 4: 3GPP TS 26.171 V5.0.0 (2001-03), 3rd Generation Partnership Project; Technical Specification Group Services and System Aspects; Speech Codec speech processing functions; “AMR Wideband speech codec; General Description”, March 2001
Non-Patent Document 5: 3GPP TS 23.228 V10.2.0 (2010-09), 3rd Generation Partnership Project; Technical Specification Group Services and System Aspects; “IP Multimedia Subsystem (IMS)”; Stage 2 (Release 10), September 2010

### SUMMARY OF INVENTION

### Technical Problems

For use of the IMS, a mobile communication apparatus utilizes a common codec that belongs to the intersection of codecs that can be used by the mobile communication apparatus and codecs that can be supported by the media gateway control function (MGCF) of the IMS. When a codec to be used by the mobile communication apparatus is selected, codecs that can be used in the correspondent communication apparatus that is connected to another network are not taken into account. Therefore, when a mobile communication apparatus that can use both the AMR-WB and the AMR-NB originates a call in a network that can use the AMR-WB, the mobile communication apparatus uses the AMR-WB.

In that case, when the correspondent communication apparatus that is connected to the other network can only use the AMR-NB, the AMR-WB is used from the originating mobile communication apparatus to the media gateway (MGW) in the IMS core network, whereas the other network uses the AMR-NB. Even though the mobile communication network side uses the AMR-WB, which has a high transmission rate, since the other network side uses the AMR-NB, which has a low transmission rate, voice eventually has low voice quality as a result of the AMR-NB. Thus, it is wasteful that the mobile communication network side consumes a wide bandwidth for the AMR-WB in light of the low voice quality which is finally obtained. Therefore, it is desirable that the wide bandwidth be reduced so that radio and core-network resources can be made available for communication performed by other users.

Accordingly, the present invention provides a core network and a communication system capable of using the bandwidth efficiently by matching, as closely as possible, the codec used at the terminating side with the codec used at the originating side.

### Solution to Problems

A core network according to the present invention is connected to a mobile communication network to which a terminating mobile communication apparatus is connected and to an originating network to which an originating communication apparatus is connected, and establishes voice communication between the communication apparatuses. The core network includes a connection-request receiver adapted for receiving, from the originating network, a connection request that includes information indicating an originating codec selected to be used in the originating network and an identifier identifying the terminating mobile communication apparatus; a termination notification transmission section adapted for transmitting, upon receiving the connection request, a termination notification to the terminating mobile communication apparatus; a termination notification-response receiver adapted for receiving a termination notification response sent from the terminating mobile communication apparatus in response to the termination notification and indicating at least one codec that can be used by the terminating mobile communication apparatus; and a codec specifying section adapted for specifying a codec that should be used by the terminating mobile communication apparatus. When the termination notification-response receiver receives the termination notification response, the codec specifying section specifies either a common codec that belongs to the intersection of the at least one codec that can be used by the terminating mobile communication apparatus, indicated in the termination notification response, codecs that can be used in the core network, and the originating codec, or a codec that can be used by the terminating mobile communication apparatus and the core network and that has a transmission rate closest to the transmission rate of the originating codec, as the codec that should be used by the terminating mobile communication apparatus.

In the present invention, in response to the connection request sent from the originating communication apparatus, the core network sends the termination notification to the terminating mobile communication apparatus and receives the termination notification response from the terminating mobile communication apparatus. The connection request indicates an originating codec selected to be used in the originating network, and the termination notification response indicates at least one codec that can be used by the terminating mobile communication apparatus. Upon receiving the termination notification response, the core network specifies either a common codec that belongs to the intersection of the at least one codec that can be used by the terminating mobile communication apparatus, indicated in the termination notification response, codecs that can be used in the core network, and the originating codec, or a codec that can be used by the terminating mobile communication apparatus and the core network and that has a transmission rate closest to the transmission rate of the originating codec, as a codec that should be used by the terminating mobile communication apparatus. By doing so, the transmission rate of the codec to be used at the terminating side is made close to the transmission rate of the codec to be used at the originating side, reducing the bandwidth waste.

For example, it is assumed that the core network and the terminating mobile communication apparatus can use both the AMR-WB and the AMR-NB, and the originating communication apparatus can use the AMR-NB. In that case, the core network specifies the AMR-NB as the codec that should be used by the terminating mobile communication apparatus. By doing so, the terminating mobile communication apparatus and the core network use the AMR-NB codec that is the same as that in the originating communication apparatus to perform voice communication. By selecting the codec to be used for voice communication in the core network in a manner adaptive to the originating communication apparatus as described above, the codec to be used at the terminating side and the codec to be used at the originating side can be matched as closely as possible. Therefore, the terminating side uses the codec having a bandwidth suited to the voice quality to be obtained, so that the mobile communication network and the core network can use the bandwidth efficiently. In other words, the bandwidth required for the codec to be used at the terminating side is reduced in conformity to the codec to be used at the originating side, so that the radio and core-network resources can be made available for communication performed by other users.

It is preferable in the core network according to the present invention that, when the connection-request receiver receives the connection request, the codec specifying section temporarily specify either the originating codec indicated in the connection request, or a codec that can be used in the core network and that has a transmission rate closest to the transmission rate of the originating codec, as a first codec that should be used by the terminating mobile communication apparatus; the termination notification transmission section transmit the termination notification, which indicates the first codec, to the terminating mobile communication apparatus; and when the termination notification-response receiver receives the termination notification response, the codec specifying section specify a common codec that belongs to the intersection of the at least one codec that can be used by the terminating mobile communication apparatus, indicated in the termination notification response, and the first codec, as a second codec that should be used by the terminating mobile communication apparatus.

Codecs that can be used for voice communication between the core network and the terminating mobile communication apparatus are common codecs that belong to the intersection of codecs that can be used in the core network and codecs that can be used by the terminating mobile communication apparatus. First, the codec specifying section specifies the originating codec as the first codec if the originating codec can be used in the core network; and specifies a codec that can be used in the core network and that has a transmission rate closest to the transmission rate of the originating codec as a first codec if the originating codec cannot be used in the core network. The second codec to be selected thereafter is a common codec that belongs to the intersection of at least one codec that can be used by the terminating mobile communication apparatus and the first codec. As a result, the second codec that should be used by the terminating mobile communication apparatus is a common codec that belongs to the intersection of codecs that can be used in the core network and codecs that can be used by the terminating mobile communication apparatus and that has the same transmission rate as or a transmission rate closest to the transmission rate of the originating codec. In other words, the codec that can be used for voice communication between the core network and the terminating mobile communication apparatus and that matches the originating codec as closely as possible is used for that voice communication.

Further, if only one codec can be used by the terminating mobile communication apparatus, and that codec is the same as the first codec, that codec should be selected in the core network as the second codec. The terminating mobile communication apparatus ensures resources for the first codec when receiving the first codec temporarily specified, and if the first codec is the same as the second codec, it is possible to reduce the time required for preparing for voice communication in the terminating mobile communication apparatus.

The core network according to the present invention may further include a storage section adapted for storing the originating codec indicated in the connection request received by the connection-request receiver. In the core network, when the connection-request receiver receives the connection request, the codec specifying section may temporarily specify a codec that can be used in the core network, as a first codec that should be used by the terminating mobile communication apparatus; the termination notification transmission section may transmit the termination notification, which indicates the first codec, to the terminating mobile communication apparatus; and when the termination notification-response receiver receives the termination notification response, the codec specifying section may specify either the common codec that belongs to the intersection of the at least one codec that can be used by the terminating mobile communication apparatus, indicated in the termination notification response, the codecs that can be used in the core network, and the originating codec stored in the storage section, or the codec that can be used by the terminating mobile communication apparatus and the core network and that has the transmission rate closest to the transmission rate of the originating codec, as a second codec that should be used by the terminating mobile communication apparatus.

Codecs that can be used for voice communication between the core network and the terminating mobile communication apparatus are common codecs that belong to the intersection of codecs that can be used in the core network and codecs that can be used by the terminating mobile communication apparatus. First, the codec specifying section temporarily specifies a codec that can be used in the core network as the first codec that should be used by the terminating mobile communication apparatus. When the first codec is specified, it is not taken into consideration whether or not the first codec is the same as the originating codec, or whether or not the first codec and the originating codec have close transmission rates. Therefore, the first codec can be signaled to the terminating mobile communication apparatus quickly. The second codec to be selected thereafter is either a common codec that belongs to the intersection of codecs that can be used by the terminating mobile communication apparatus, codecs that can be used in the core network, and the originating codec, or a codec that can be used by the terminating mobile communication apparatus and the core network and that has a transmission rate closest to the transmission rate of the originating codec. Therefore, there is a low possibility that the first codec specified temporarily is the same as the second codec specified later. However, the terminating mobile communication apparatus ensures resources for the first codec when receiving the first codec temporarily specified, and if the first codec is the same as the second codec, the resources temporarily ensured for the first codec can be used without change for voice communication between the terminating mobile communication apparatus and the core network, so that the time required for preparing for the voice communication might be reduced. In addition, since the first codec is specified irrespective of the originating codec, the time required for specifying the first codec is short, and as a result, the time for the entire terminating procedure may be reduced.

A communication system according to the present invention includes the above-described core network, a mobile communication network connected to the core network, and a mobile communication apparatus that connects to the mobile communication network. The mobile communication apparatus receives the termination notification from the core network and sends, to the core network in response to the termination notification, the termination notification response, indicating the at least one codec that can be used by the mobile communication apparatus.

By selecting the codec to be used for voice communication in the core network in a manner adapted to the originating communication apparatus, as described above, the codec used at the terminating side and the codec used at the originating side can be matched as closely as possible.

### BRIEF DESCRIPTION OF THE DRAWINGS

FIG. 1 is a block diagram showing the overall communication system according to embodiments of the present invention.

FIG. 2A is a part of a sequence diagram indicating an example information flow in a communication system according to a first embodiment of the present invention.

FIG. 2B is a part of the sequence diagram, following the part in FIG. 2A.

FIG. 3 is a part of a sequence diagram indicating an information flow in a communication system according to a second embodiment of the present invention.

### DESCRIPTION OF EMBODIMENTS

Various embodiments of the present invention will be described below with reference to the attached drawings.

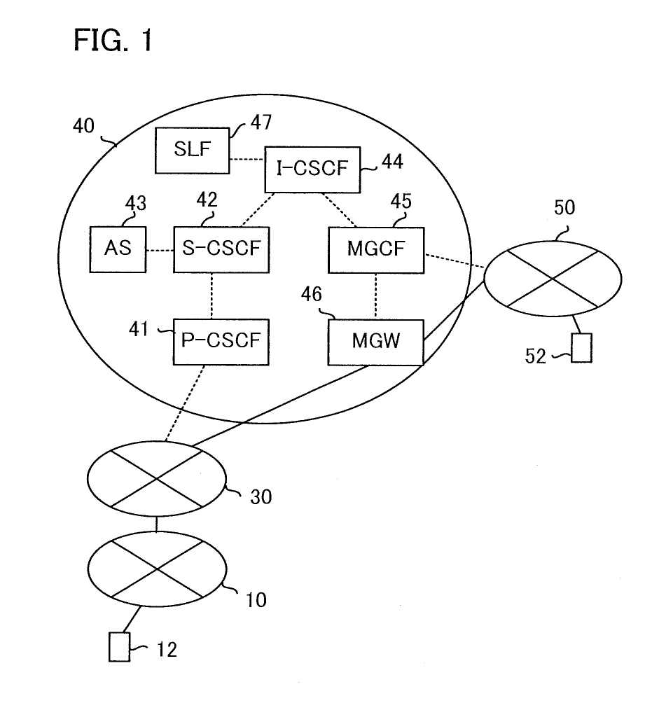

As shown in FIG. 1, a communication system according to embodiments of the present invention includes a mobile communication network 10, an evolved packet core (EPC) 30, and a core network 40. A large number of mobile communication apparatuses 12 are connected to the mobile communication network 10. The mobile communication apparatuses 12 are, for example, cell phones and other communication apparatuses having a voice communication function. The mobile communication network 10 conforms, for example, to long term evolution (LTE), but the specifications thereof are not limited to LTE. The EPC 30 manages the mobility of each of the mobile communication apparatuses 12. In the following description, the mobile communication apparatuses 12 may be called user equipments (UEs).

A plurality of external networks 50 are connected to the core network 40. The external networks 50 are circuit switching networks, such as public switched telephone networks (PSTNs) or public line mobile networks (PLMNs), or other networks (for example, networks conforming to SIP-I, in which ISUP messages are encapsulated within SIP messages and sent). A large number of communication apparatuses 52, such as cell phones or fixed-line telephones, are connected to each of the external networks 50. Therefore, the core network 40 establishes communication (including voice communication) between a mobile communication apparatus 12 connected to the mobile communication network 10 and capable of communicating via the IMS and a communication apparatus 52 connected to an external network 50.

The core network 40 is an IMS core network. The core network 40 includes various entities in addition to those shown in the figure, but includes the following main entities.

A proxy call session control function (P-CSCF) 41 is a session initiation protocol (SIP) router that receives SIP messages from the mobile communication apparatus 12 and sends SIP messages to the mobile communication apparatus 12.

A serving call session control function (S-CSCF) 42 is an SIP router providing the following functions:
Managing the registration information and the provided service information of users.
Managing user sessions.
Selecting an application server 43 that provides a service for each user.
   The S-CSCF 42 also has a routing function based on the telephone numbers of terminating apparatuses.

The application server (AS) 43 provides a voice application by using SIP. Invoice communication between users, the AS 43 provides, for example, additional services such as voice guidance.

When the mobile communication network 10 receives a call from the external network 50, an interrogating-CSCF (I-CSCF) 44 queries a subscriber location function (SLF) 47 about the location information of the terminating mobile communication apparatus 12, and selects an S-CSCF to be used for communication with the mobile communication apparatus 12 according to the location information of the mobile communication apparatus 12. In other words, the I-CSCF 44 receives an SIP message and routes the SIP message to the S-CSCF.

The media gateway control function (MGCF) 45 is a breakout point to a circuit switching network, in the IMS core network 40. The MGCF 45 handles C-plane control protocol conversion between the IMS core network 40 and the external network 50. Specifically, the MGCF 45 handles conversion between the SIP used in IMS control signals, and the ISDN user part (ISUP) or the bearer independent call control (BICC) used in control signals in a circuit switching network. The MGCF 45 controls the resources of a media gateway (MGW) 46 by using the H.248 protocol or the like.

The media gateway (MGW) 46 has an interface function for user data, such as voice, in the user plane (U-plane) when connected to the external network 50. Specifically, when the codec used from a mobile communication apparatus 12 to the core network 40 and the codec used in an external network 50 are not the same, the MGW performs code conversion between the codecs.

In FIG. 1, in the core network 40, dotted lines indicate the C-plane and solid lines indicate the U-plane. The U-plane is also called a media plane in the IMS.

### First Embodiment

It is assumed that the communication apparatus 52 that connects to the external network 50 originates a call in order to perform voice communication with the mobile communication apparatus 12 that is capable of communicating via the IMS and that connects to the mobile communication network 10.

In that case, the originating external network 50 sends an ISUP initial address message (IAM) as a connection request. The IAM includes information indicating the originating codec selected to be used in the originating external network 50, and an identifier identifying the terminating mobile communication apparatus 12. The codec selected to be used in the originating external network 50 can be used in the external network 50 and can also be used in the communication apparatus 52.

The IAM is received by the MGCF (connection-request receiver) 45. Upon receiving the IAM, the MGCF (termination notification transmission section) 45 sends a termination notification (SIP_INVITE) to the terminating mobile communication apparatus 12. More specifically, the MGCF 45 sends SIP_INVITE to the I-CSCF 44, and the I-CSCF 44 queries the SLF 47 about the location information of the mobile communication apparatus 12 and selects an S-CSCF 42 suited to the location of the mobile communication apparatus 12. The I-CSCF 44 transfers SIP_INVITE to the selected S-CSCF 42. The S-CSCF 42 selects a P-CSCF 41 to be used for communication with the mobile communication apparatus 12 on the basis of the telephone number of the mobile communication apparatus 12, and transfers SIP_INVITE to the P-CSCF 41. The P-CSCF 41 transfers SIP_INVITE to the mobile communication apparatus 12. SIP_INVITE reaches the terminating mobile communication apparatus 12 through the EPC 30 and the mobile communication network 10.

In response to SIP_INVITE, the terminating mobile communication apparatus 12 sends a termination notification response (SIP_{—}183 message (session progress)) indicating at least one codec that can be used by the terminating mobile communication apparatus 12. The P-CSCF 41 (termination notification-response receiver) receives the SIP_{—}183 message. The SIP_{—}183 message reaches the MGCF 45 through the S-CSCF 42 and the I-CSCF 44.

The MGCF 45 (codec Specifying Section) has a function of specifying a codec that should be used by the terminating mobile communication apparatus 12. Specifying the codec includes two stages.

First, upon receiving a connection request (IAM) from the external network 50, the MGCF 45 temporarily specifies either the originating codec indicated by the IAM or a codec that can be used in the IMS core network 40 and that has a transmission rate closest to the transmission rate of the originating codec, as a first codec that should be used by the terminating mobile communication apparatus 12. More specifically, if the originating codec can be used in the core network 40, that originating codec is specified as the first codec; and, if the originating codec cannot be used in the core network 40, a codec that can be used in the core network 40 and that has a transmission rate closest to the transmission rate of the originating codec is specified as the first codec. The MGCF 45 (termination notification transmission section) sends a termination notification (SIP_INVITE) indicating the first codec to the terminating mobile communication apparatus 12.

Thereafter, upon receiving the termination notification response (SIP_{—}183 message) indicating at least one codec that can be used by the terminating mobile communication apparatus 12, the MGCF 45 specifies a common codec that belongs to the intersection of the at least one codec that can be used by the terminating mobile communication apparatus 12, indicated in the termination notification response, and the first codec, as a second codec that should be used by the terminating mobile communication apparatus 12.

The MGCF 45 functions as a second codec notification transmission section, and sends a second codec notification (SIP_PRACK) to the terminating mobile communication apparatus 12. SIP_PRACK reaches the terminating mobile communication apparatus 12 through the I-CSCF 44, the S-CSCF 42, and the P-CSCF 41, and then through the EPC 30 and the mobile communication network 10.

The second codec, selected in the latter stage, is a common codec that belongs to the intersection of the at least one codec that can be used by the terminating mobile communication apparatus 12 and the first codec. As a result, the second codec, which should be used by the terminating mobile communication apparatus 12, is a common codec that belongs to the intersection of codecs that can be used in the core network 40 and codecs that can be used by the terminating mobile communication apparatus 12 and that has the same transmission rate as or a transmission rate closest to the transmission rate of the originating codec. In other words, the second codec is either a common codec that belongs to the intersection of at least one codec that can be used by the terminating mobile communication apparatus 12, codecs that can be used in the core network 40, and the originating codec, or a codec that has a transmission rate closest to the transmission rate of the originating codec and that can be used by the terminating mobile communication apparatus 12 and the core network 40. In summary, a codec that can be used for voice communication between the core network 40 and the terminating mobile communication apparatus 12 and that has a transmission rate as close as possible to the transmission rate of the originating codec is used for that voice communication. By doing so, the transmission rate of the codec to be used at the terminating side is made close to the transmission rate of the codec to be used at the originating side, reducing the bandwidth waste.

For example, it is assumed that the core network 40 and the terminating mobile communication apparatus 12 can use both the AMR-WB and the AMR-NB, and that the originating communication apparatus 52 can use the AMR-NB. In that case, the core network 40 specifies the AMR-NB as the second codec, which should be used by the terminating mobile communication apparatus 12. By doing so, the terminating mobile communication apparatus 12 and the core network 40 use the AMR-NB that is the same as that in the originating communication apparatus 52 to perform voice communication. By selecting the codec to be used for voice communication in the core network 40 in a manner adaptive to the originating communication apparatus 52 as described above, the codec to be used at the terminating side and the codec to be used at the originating side can be matched as closely as possible. Therefore, the terminating side uses the codec having a bandwidth suited to the voice quality to be obtained, so that the mobile communication network and the core network can use the bandwidth efficiently. In other words, the bandwidth required for the codec to be used at the terminating side is reduced in conformity to the codec to be used at the originating side, so that the radio and core-network resources can be made available for communication performed by other users.

If only one codec can be used by the terminating mobile communication apparatus 12, and that codec is the same as the first codec, that codec is specified as the second codec by the MGCF 45. If the terminating mobile communication apparatus ensures resources for the first codec when receiving the first codec temporarily specified, the terminating mobile communication apparatus 12, and if the first codec is the same as the second codec, it is possible to reduce the time required for preparing for voice communication in the terminating mobile communication apparatus 12.

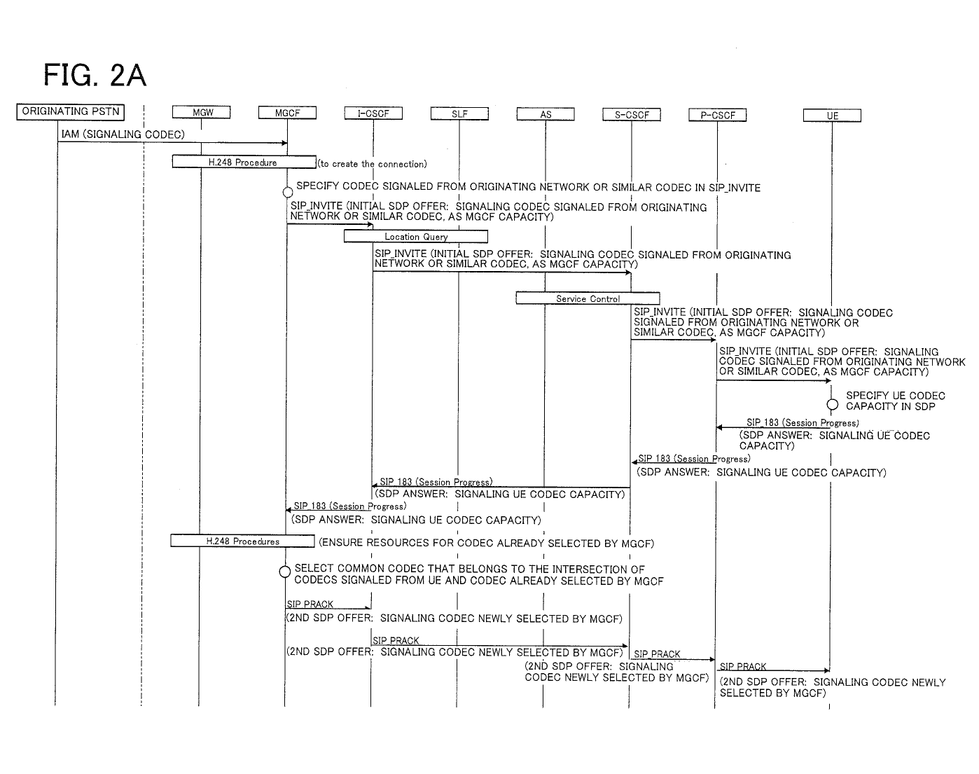

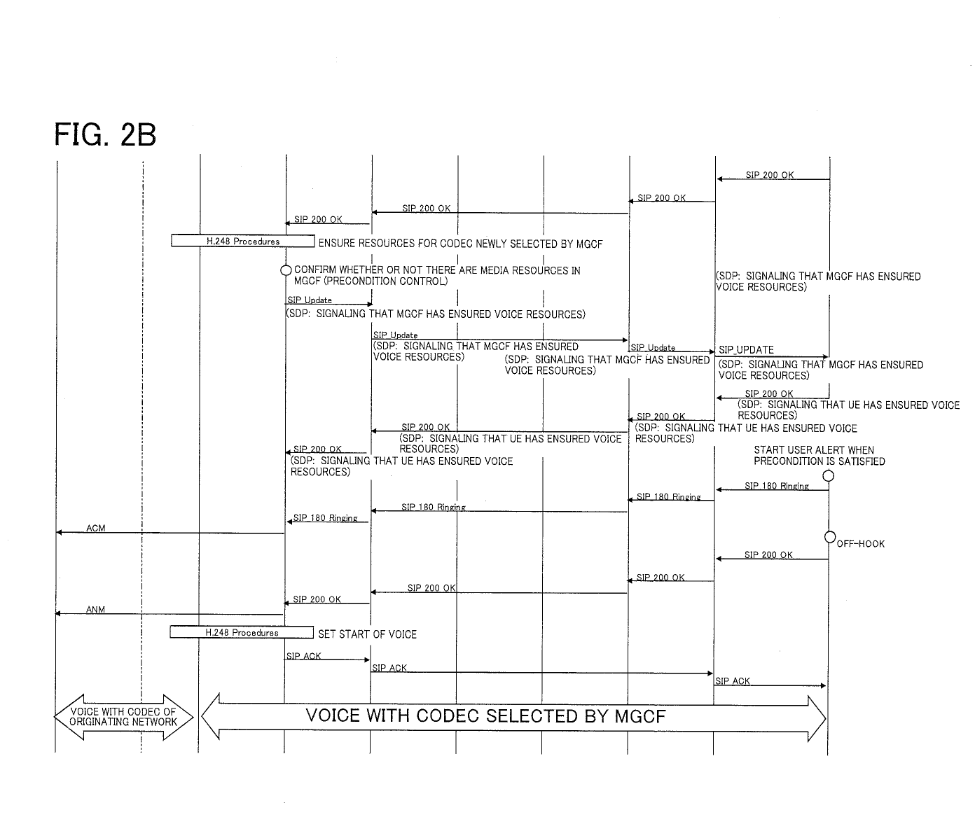

An example information flow in a communication system according to the first embodiment will be described below with reference to FIG. 2A and FIG. 2B. For convenience, the mobile communication network 10 and the EPC 30 are omitted in the figures. In the following description, it is assumed that a communication apparatus 52 connected to an external network 50 originates a call in order to perform voice communication with a UE. In this example, the originating network is a PSTN, but it maybe another circuit switching network, such as a PLMN, or another type of network.

The telephone number of the terminating mobile communication apparatus 12 is input to the communication apparatus 52. The originating PSTN sends an IAM to the MGCF 45 (connection-request receiver) as a connection request that indicates the originating codec and an identifier (such as the telephone number) identifying the terminating mobile communication apparatus 12.

Upon receiving the IAM, the MGCF selects an MGW to be used for this voice communication, and activates the MGW by using the H.248 protocol. The MGCF 45 (codec specifying section) also specifies either the originating codec signaled from the originating network, or a codec that has a transmission rate close to the transmission rate of the originating codec and that can be used in the IMS core network 40, as the first codec. The MGCF 45 (termination notification transmission section) generates SIP_INVITE that includes Initial SDP Offer describing the first codec, according to the session description protocol (SDP), and sends it to the I-CSCF 44. The I-CSCF 44 queries of the SLF 47 about the location information of the mobile communication apparatus 12, and transfers SIP_INVITE to an S-CSCF 42 suited to the location of the mobile communication apparatus 12.

Upon receiving SIP_INVITE, the S-CSCF 42 requests the AS to perform service control, if necessary, and also selects a P-CSCF 41 to be used for communication with the mobile communication apparatus 12 on the basis of the telephone number of the terminating mobile communication apparatus 12 and transfers SIP_INVITE to the P-CSCF 41. The P-CSCF 41 transfers SIP_INVITE to the mobile communication apparatus 12.

Upon receiving SIP_INVITE, the UE generates an SIP_{—}183 message (session progress) that includes SDP Answer describing the codec capacity of the UE (codecs that can be used by the UE) and sends it. The P-CSCF 41 (termination notification-response receiver) receives the SIP_{—}183 message. The SIP_{—}183 message reaches the MGCF 45 through the S-CSCF 42 and the I-CSCF 44.

On the other hand, the MGCF 45 uses the H.248 protocol to signal the codec already selected by the MGCF (that is, the first codec) to the MGW, and the MGW ensures resources required for the codec.

Upon receiving the termination notification response (SIP_{—}183 message) indicating at least one codec that can be used by the UE, the MGCF 45 specifies a common codec that belongs to the intersection of the codec that can be used by the UE, indicated in the SIP_{—}183 message, and the codec already selected by the MGCF (that is, the first codec) as the second codec that should be used by the UE.

The MGCF 45 (second codec notification transmission section) sends a second codec notification (SIP_PRACK) that includes 2nd SDP Offer indicating the codec newly selected by the MGCF (that is, the second codec) to the UE. SIP_PRACK reaches the UE through the I-CSCF 44, the S-CSCF 42, and the P-CSCF 41.

Referring now to FIG. 2B, the UE sends back SIP_{—}200 OK to the core network 40. SIP_{—}200 OK is received by the P-CSCF and reaches the MGCF through the S-CSCF and the I-CSCF. The MGCF uses the H.248 protocol to signal the codec newly selected by the MGCF (that is, the second codec) to the MGW, and the MGW ensures resources required for the codec.

Upon receiving SIP_{—}200 OK, the MGCF confirms whether or not voice-media resources have been ensured inside the MGCF (precondition control). After the confirmation, the MGCF sends SIP_Update signaling that the MGCF has ensured the resources to the UE.

Upon receiving SIP_Update, the UE sends SIP_{—}200 OK for signaling that the voice-media resources have been ensured inside the UE to the MGCF. When the voice-media resources have been ensured inside the UE (when the precondition is satisfied), the UE starts USER ALERT and sends SIP_{—}180 Ringing to the MGCF. This message indicates that the terminating apparatus is being called. Upon receiving SIP_{—}180 Ringing, the MGCF sends an ISUP address complete message (ACM) to the external originating network 50.

Further, when the user of the UE responds to the calling and the UE becomes off-hook, the UE sends SIP_{—}200 OK. Upon receiving SIP_{—}200 OK, the MGCF sends an answer message (ANM) to the external originating network 50. Then, the MGCF uses the H.248 protocol to signal to the MGW that the communication apparatus 52 has become off-hook and voice-media communication has started. Then, the MGCF sends SIP_ACK to the UE.

### Second Embodiment

A second embodiment is basically similar to the first embodiment, and the MGCF (codec specifying section) 45 specifies a codec that should be used by the terminating mobile communication apparatus 12 in the two stages. In the second embodiment, however, the first codec and the second codec that should be used by the terminating mobile communication apparatus 12 are different from those used in the first embodiment. Differences from the first embodiment will be mainly described below.

First, upon receiving a connection request (IAM) from the external network 50, the MGCF (storage section) 45 stores the originating codec indicated in the IAM, and also temporarily specifies one of codecs that can be used in the IMS core network 40 as the first codec that should be used by the terminating mobile communication apparatus 12 irrespective of the originating codec indicated in the IAM. When the first codec is specified, it is not taken into consideration whether or not the first codec is the same as the originating codec, or whether or not the first codec and the originating codec have close transmission rates. Therefore, the first codec can be signaled to the terminating mobile communication apparatus quickly. The MGCF (termination notification transmission section) sends a termination notification (SIP_INVITE) indicating the first codec to the terminating mobile communication apparatus 12.

Thereafter, upon receiving the termination notification response (SIP_{—}183 message) indicating at least one codec that can be used by the terminating mobile communication apparatus 12, the MGCF 45 specifies a common codec that belongs to the intersection of the at least one codec that can be used by the terminating mobile communication apparatus 12, indicated in the termination notification response, codecs that can be used in the core network 40, and the originating codec stored in the storage section, as the second codec that should be used by the terminating mobile communication apparatus 12. If there is no common codec, a codec that can be used by the terminating mobile communication apparatus 12 and the core network 40, and that has a transmission rate closest to the transmission rate of the originating codec is specified as the second codec that should be used by the terminating mobile communication apparatus 12.

The MGCF 45 functions as a second codec notification transmission section and sends a second codec notification (SIP_PRACK) to the terminating mobile communication apparatus 12. SIP_PRACK reaches the terminating mobile communication apparatus 12 through the I-CSCF 44, the S-CSCF 42, and the P-CSCF 41, and then through the EPC 30 and the mobile communication network 10.

Since the first codec, which is specified temporarily and quickly, is specified irrespective of the originating codec, there is a low possibility that the first codec is the same as the second codec and is specified as the second codec. However, the terminating mobile communication apparatus ensures resources for the first codec when receiving the first codec temporarily specified, and if the first codec is the same as the second codec, the resources temporarily ensured for the first codec can be used without change for voice communication between the terminating mobile communication apparatus 12 and the core network 40, so that the time required for preparing for the voice communication might be reduced. In addition, since the first codec is specified irrespective of the originating codec, the time required for specifying the first codec is short, and as a result, the time for the entire terminating procedure may be reduced.

The second codec, selected in the latter stage, is either a common codec that belongs to the intersection of the at least one codec that can be used by the terminating mobile communication apparatus 12, codecs that can be used in the core network 40, and the originating codec, or a codec that can be used by the terminating mobile communication apparatus 12 and the core network 40 and that has a transmission rate closest to the transmission rate of the originating codec. In other words, the codec that can be used for voice communication between the core network 40 and the terminating mobile communication apparatus 12 and that has a transmission rate as close as possible to the transmission rate of the originating codec is used for that voice communication. By doing so, the transmission rate of the codec to be used at the terminating side is made close to the transmission rate of the codec to be used at the originating side, reducing the bandwidth waste.

For example, it is assumed that the core network 40 and the terminating mobile communication apparatus 12 can use both the AMR-WB and the AMR-NB, and the originating communication apparatus 52 can use the AMR-NB. In that case, the core network 40 specifies the AMR-NB as the second codec, which should be used by the terminating mobile communication apparatus 12. By doing so, the terminating mobile communication apparatus 12 and the core network 40 use the AMR-NB codec that is the same as that in the originating communication apparatus 52 to perform voice communication. By selecting the codec to be used for voice communication in the core network 40 in a manner adaptive to the originating communication apparatus 52 as described above, the codec to be used at the terminating side and the codec to be used at the originating side can be matched as closely as possible. Therefore, the terminating side uses the codec having a bandwidth suited to the voice quality to be obtained, so that the mobile communication network and the core network can use the bandwidth efficiently. In other words, the bandwidth required for the codec to be used at the terminating side is reduced in conformity to the codec to be used at the originating side, so that the radio and core-network resources can be used for communication performed by others.

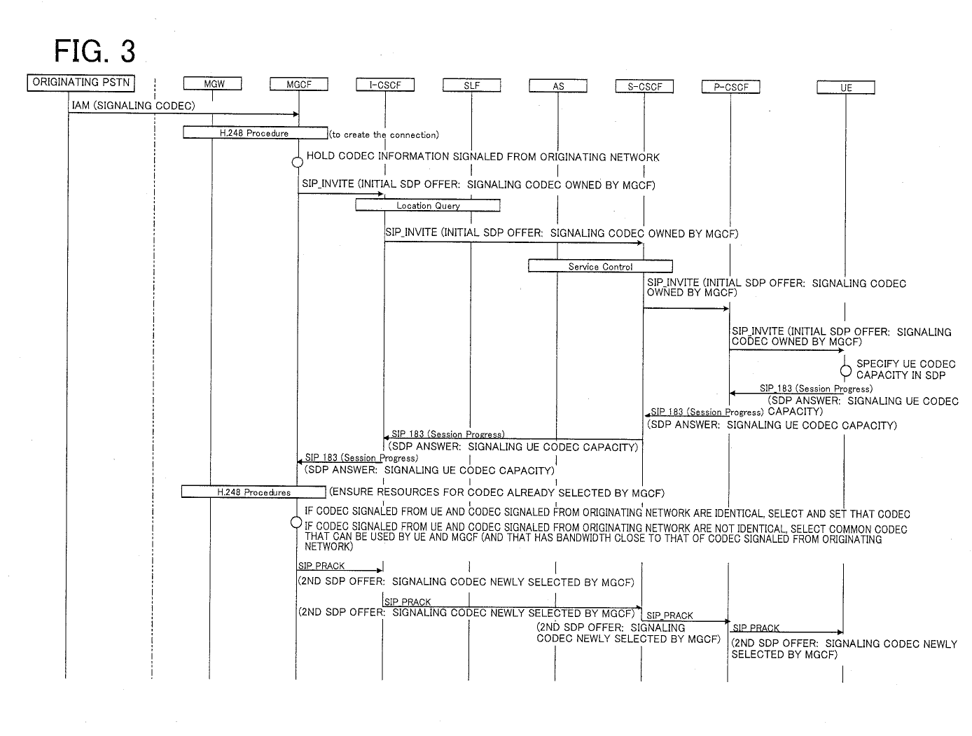

An example information flow in the communication system according to the second embodiment will be described below with reference to FIG. 3. In the same way as in FIGS. 2A and 2B, for convenience, the mobile communication network 10 and the EPC 30 are omitted in the figures. In the following description, it is assumed that a communication apparatus 52 connected to an external network 50 originates a call in order to perform voice communication with an UE. In this example, the originating network is the PSTN, but it may be another circuit switching network, such as a PLMN, or another type of network.

The telephone number of the terminating mobile communication apparatus 12 is input to the communication apparatus 52. The originating PSTN sends an IAM to the MGCF 45 (connection-request receiver) as a connection request that indicates the originating codec and an identifier identifying the terminating mobile communication apparatus 12 (such as the telephone number).

Upon receiving the IAM, the MGCF selects an MGW to be used for this voice communication, and activates the MGW by using the H.248 protocol. The MGCF 45 (storage section) also holds, that is, stores, the originating codec signaled from the originating network. The MGCF 45 (codec specifying section) also specifies one of codecs that can be used in the IMS core network 40 (codec owned by the MGCF), as a first codec, irrespective of the originating codec or the transmission rate thereof. The MGCF 45 (termination notification transmission section) generates SIP_INVITE that includes Initial SDP Offer describing the first codec, according to the session description protocol (SDP), and sends it to the I-CSCF 44. The I-CSCF 44 queries the SLF 47 about the location information of the mobile communication apparatus 12, and transfers SIP_INVITE to an S-CSCF 42 suited to the location of the mobile communication apparatus 12.

Upon receiving SIP_INVITE, the S-CSCF 42 requests the AS to perform service control, if necessary, and also selects a P-CSCF 41 to be used for communication with the mobile communication apparatus 12 on the basis of the telephone number of the terminating mobile communication apparatus 12 and transfers SIP_INVITE to the P-CSCF 41. The P-CSCF 41 transfers SIP_INVITE to the mobile communication apparatus 12.

Upon receiving SIP_INVITE, the UE generates an SIP_{—}183 message (session progress) that includes an SDP answer describing the codec capacity of the UE (codecs that can be used by the UE) and sends it. The P-CSCF 41 (termination notification-response receiver) receives the SIP_{—}183 message. The SIP_{—}183 message reaches the MGCF 45 through the S-CSCF 42 and the I-CSCF 44.

The MGCF 45 uses the H.248 protocol to signal the codec already selected by the MGCF (that is, the first codec) to the MGW, and the MGW ensures resources required for the codec.

Upon receiving the termination notification response (SIP_{—}183 message) indicating at least one codec that can be used by the UE, the MGCF 45 specifies the second codec. The MGCF 45 specifies a common codec that belongs to the intersection of the at least one codec that can be used by the UE, indicated in the SIP_{—}183 message, codecs that can be used in the core network 40, and the originating codec stored in the storage section, as the second codec that should be used by the terminating mobile communication apparatus 12. If there is no common codec, however, a codec that can be used by the UE and the core network 40 and that has a transmission rate closest to the transmission rate of the originating codec is specified as the second codec that should be used by the UE.

The MGCF 45 (second codec notification transmission section) sends a second codec notification (SIP_PRACK) that includes 2nd SDP Offer indicating the codec newly selected by the MGCF (that is, the second codec) to the UE. SIP_PRACK reaches the UE through the I-CSCF 44, the S-CSCF 42, and the P-CSCF 41.

The subsequent steps are the same as those described in the first embodiment with reference to FIG. 2B.

### Other Modifications

In the above-described embodiments, example codecs are the AMR-WB and the AMR-NB. Other codecs may be used in the communication system.

In the above-described embodiments, the core network 40 is an IMS core network. A core network according to the present invention is not limited to an IMS core network.

In the above-described embodiments, the identifier used to identify the originating communication apparatus is the telephone number of the originating communication apparatus.

However, other identifiers may be used.

### REFERENCE NUMERALS

10: Mobile communication network
12: Mobile communication apparatus
30: EPC
40: Core network
41: P-CSCF (termination notification-response receiver)
42: S-CSCF
43: AS
44: I-CSCF
45: MGCF (connection-request receiver, termination notification transmission section, codec specifying section, storage section)
46: MGW
50: External network
52: Communication apparatus

1. A core network connected to a mobile communication network to which a terminating mobile communication apparatus is connected and to an originating network to which an originating communication apparatus is connected, and establishing voice communication between the communication apparatuses, the core network comprising:
a connection-request receiver adapted for receiving, from the originating network, a connection request that includes information indicating an originating codec selected to be used in the originating network and an identifier identifying the terminating mobile communication apparatus;
a termination notification transmission section adapted for transmitting, upon receiving the connection request, a termination notification to the terminating mobile communication apparatus;
a termination notification-response receiver adapted for receiving a termination notification response sent from the terminating mobile communication apparatus in response to the termination notification and indicating at least one codec that can be used by the terminating mobile communication apparatus; and
a codec specifying section adapted for specifying a codec that should be used by the terminating mobile communication apparatus;
wherein, when the termination notification-response receiver receives the termination notification response, the codec specifying section specifies either a common codec that belongs to the intersection of the at least one codec that can be used by the terminating mobile communication apparatus, indicated in the termination notification response, codecs that can be used in the core network, and the originating codec, or a codec that can be used by the terminating mobile communication apparatus and the core network and that has a transmission rate closest to the transmission rate of the originating codec, as the codec that should be used by the terminating mobile communication apparatus.

2. The core network according to claim 1, wherein, when the connection-request receiver receives the connection request, the codec specifying section temporarily specifies either the originating codec indicated in the connection request, or a codec that can be used in the core network and that has a transmission rate closest to the transmission rate of the originating codec, as a first codec that should be used by the terminating mobile communication apparatus;
the termination notification transmission section transmits the termination notification, which indicates the first codec, to the terminating mobile communication apparatus; and
when the termination notification-response receiver receives the termination notification response, the codec specifying section specifies a common codec that belongs to the intersection of the at least one codec that can be used by the terminating mobile communication apparatus, indicated in the termination notification response, and the first codec, as a second codec that should be used by the terminating mobile communication apparatus.

3. The core network according to claim 1, further comprising a storage section adapted for storing the originating codec indicated in the connection request received by the connection-request receiver,
wherein, when the connection-request receiver receives the connection request, the codec specifying section temporarily specifies a codec that can be used in the core network, as a first codec that should be used by the terminating mobile communication apparatus;
the termination notification transmission section transmits the termination notification, which indicates the first codec, to the terminating mobile communication apparatus; and
when the termination notification-response receiver receives the termination notification response, the codec specifying section specifies either the common codec that belongs to the intersection of the at least one codec that can be used by the terminating mobile communication apparatus, indicated in the termination notification response, the codecs that can be used in the core network, and the originating codec stored in the storage section, or the codec that can be used by the terminating mobile communication apparatus and the core network and that has the transmission rate closest to the transmission rate of the originating codec, as a second codec that should be used by the terminating mobile communication apparatus.

4. A communication system comprising:
the network according to claim 1;
a mobile communication network connected to the core network; and
a mobile communication apparatus that connects to the mobile communication network; wherein
the mobile communication apparatus is adapted for receiving the termination notification from the core network and is adapted for sending, to the core network in response to the termination notification, the termination notification response, indicating the at least one codec that can be used by the mobile communication apparatus.
